(19) United States
(12) Patent Application Publication
(10) Pub. No.: US 2021/0189879 A1
(43) Pub. Date: Jun. 24, 2021

(54) Thrust Vectoring Ignition Chamber Engine with Scotch-Yoke based Two Phase Fuel Compression System

(71) Applicant: Ravi Shankar Gautam, Gaya (IN)

(72) Inventor: Ravi Shankar Gautam, Gaya (IN)

(21) Appl. No.: 17/262,729

(22) PCT Filed: Jul. 25, 2019
(86) PCT No.: PCT/IN2019/050544

§ 371 Date: Jan. 24, 2021

(30) Foreign Application Priority Data
Jul. 25, 2018 (IN) 201821027867

(51) Int. Cl. F01B 9/02; F02B 75/32; F02M 61/14

(52) U.S. Cl. CPC F01B 9/023; F02M 2700/07; F02M 61/14; F02B 75/32

(57) ABSTRACT

This patent discloses thrust vectoring ignition chamber engine. Thrust vectoring ignition chamber used in this engine is an annular cylinder having nozzles mounted in a way such that during fuel suction phase they are sealed and during ignition of fuel they are unsealed so that hot jets of ignited fuel escaping through nozzles cause coupled rotatory motion on the ignition chamber. Engine uses cam operated specially designed bilaterally operated double action scotch-yoke mechanism which facilitates two phase suction and compression of fuel and facilitates separation of fuel valve from ignition chamber. Flywheel mounted on extension of ignition chamber functions as output of the engine. Each half rotation of flywheel completes three phases namely fuel/air suction, compression and combustion. Thus this engine fires for every half revolution and therefore can give improved power boost.

### FIELD OF THE INVENTION

The present disclosure relates generally to engine which can use petrol, diesel, compressed natural gas etc as fuel.

### BACKGROUND OF THE INVENTION

To be able to distinguish humans from trees mobility plays a key role. Automobile have played significant role in enhancing human civilization by transporting agricultural products, construction material to build better homes etc. There has been lot of effort in improving various parts of the engine in order to increase its fuel efficiency. This invention is an effort in this direction.

In automobile engines we need output which can rotate wheels. All automobile engines consist of cylindrical ignition chamber in which a piston is slip fit and is allowed to move back and forth at cylinder's rear end. Fuel-air mixture that ignition chamber received from an inlet valve (located at front end) is compressed and ignited to cause sudden expansion of gas which in turn causes thrust to the piston forcing in move rearwards. Connecting rods connecting the piston to crank shaft helps to convert translation motion of piston to rotatory motion of crankshaft which in turn causes flywheel (that is axially attached to crankshaft) to rotate. Flywheel causes wheel of automobile to rotate via transmission mechanism. One cycle of a four stroke engine for generating thrust from fuel consists of four phases namely fuel-air mixture suction, fuel-air mixture compression, ignition via spark plug (that causes thrust) and exhaust of burnt gas through exhaust valve located on the front end of ignition chamber. Each phase requires one strokes of piston and hence one cycle involves two rotations of crankshaft and therefore flywheel.

### DISADVANTAGES IN THE PRIOR ART

One of the drawbacks of four stroke engine is one phase of exhaust of burnt fuel gas is unproductive.

One of the drawbacks of four stroke engine is that it requires conversion of translation motion to rotatory motion for compression of fuel-air mixture as well as rotation of crankshaft.

One of the drawbacks of four stroke engine is that moving parts like inlet valves and exhaust valve comes in contact with ignited fuel gas mixture due to which it requires overhaul and maintenance. For example unmaintained valves may cause fuel backfire etc.

One of the drawbacks of four stroke engine is that it requires complex process and lot of moving parts to operate cam mechanisms for operating inlet and exhaust valves.

One of the drawbacks of two stroke engine is that exhaust gas and fuel gets mixed which causes lot of pollution.

### SUMMARY

One of the objectives is to provide an engine which can directly convert fuel thrust to rotatory motion. This is achieved by thrust vectored exit of ignited fuel-air mixture. Ignited fuel-air mixture is bound to escape through pair of angled nozzles located at diametrically opposite sides of ignition chamber. Nozzles are angled with each nozzle making an acute angle with respect to outward radial direction. Difference between angles that nozzles make with the line joining them is 180 degree so that the exhaust of gas cause coupled torque on the ignition chamber.

In the engine, according to this invention, piston based compression mechanism have been retained to achieve high compression.

In the engine, according to this invention, each half rotation of flywheel completes three phases namely fuel/air suction, compression and combustion, instead of two rotations as required in engine according to prior art. Thus this engine improves power boost.

Engine, according to this invention, do not require a separate phase for exhaust of burnt gas and do not cause mixing of exhaust gas with fuel as well.

In the engine, according to this invention, ignition chamber directly operates the cam mechanism without involving large number of moving parts.

Engine, according to this invention, uses cam operated specially designed multi-purpose bilaterally operated double action front dwell scotch-yoke mechanism which facilitates two phase suction and compression of fuel and facilitates separation of fuel valve from ignition chamber.

### BRIEF DESCRIPTION OF THE DRAWINGS

FIG. 1 Thrust vectoring ignition chamber engine, according to this invention, with nozzle seal in closed state.

FIG. 2 and FIG. 3 Rear and side view thrust vectoring ignition chamber of the engine according to this invention. Nozzle seal is in open state.

FIG. 4 and FIG. 5 Left and right side view of fuel supply system of the engine according to this invention

FIG. 4 and FIG. 5 Left and right side view of fuel supply system of the engine according to this invention

FIG. 6 and FIG. 7 Left and right side view of front piston chamber of the engine, according to this invention, illustrating spark plug conduit pipe

FIG. 8 Air compression chamber with fuel valve

FIG. 9, FIG. 10 and FIG. 11 Side, front and rear view of special type of bilaterally operated double action front dwell scotch yoke mechanism used in the engine according to this invention.

FIG. 12 Variation of thrust vectoring ignition chamber of the engine having static nozzle seal.

### DETAILED DESCRIPTION OF THE PREFERRED EMBODIMENT

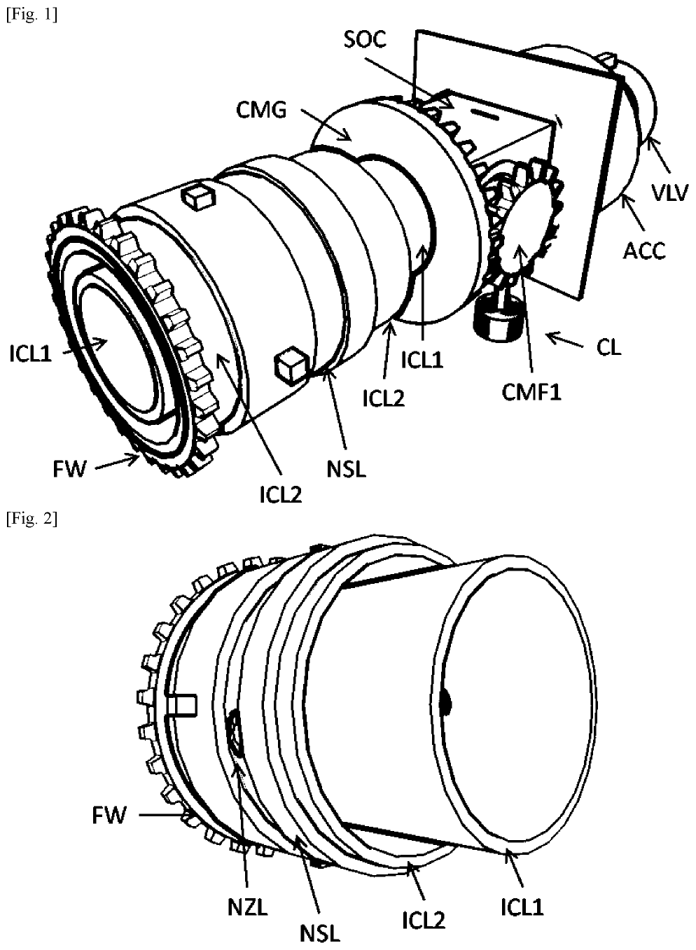

Referring to FIG. 1, the preferred embodiment of an automobile engine (1) according to this invention is shown to include an engine enclosure (ENC), thrust vectoring ignition chamber (IC), fuel supply system (FSS), nozzle seal (NSL), and flywheel (FW).

Engine enclosure (ENC) appropriately secures all parts of engine, provides support to engine via rectangular slabs attached to outer static parts of engine like nozzle seal, scotch yoke operation chamber of fuel supply system (FSS) and provides exit to the burnt fuel gas via exhaust pipe.

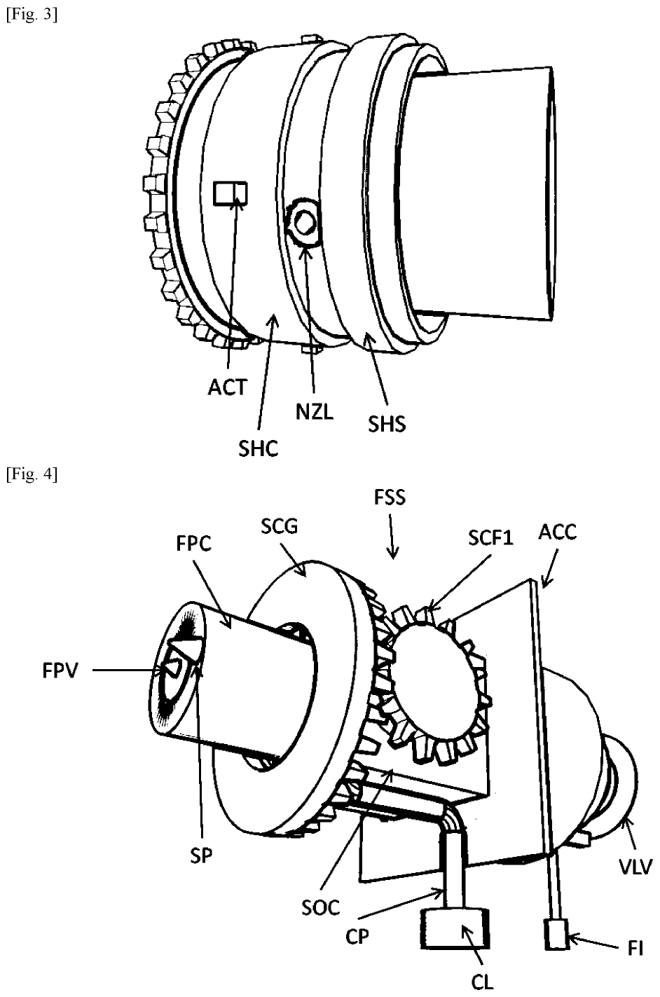

Thrust vectoring ignition chamber (IC), as shown in FIGS. 2 and 3, consists of a pair of coaxial annular cylinders, an inner annular cylinder (ICL1) and an outer annular cylinder (ICL2), connected coaxially via coaxial rings (IR), and coupled thrust vectoring nozzle (NZL) wherein
inner annular cylinder (ICL1) is coaxially fixedly caped at its front side by ignition chamber seal (ICS), which is a circular disk;
fuel supply system (FSS) is mounted on rear side of the ignition chamber;
coupled thrust vectoring nozzle (NZL) is a pair of conical tubes mounted at diametrically opposite points on the right circular section on the middle part of ignition chamber by passing through holes on the inner annular cylinder (ICL1) and outer annular cylinder (ICL2) such that one end with bigger aperture opens inside the inner annular cylinder (ICL1) and other end with smaller aperture opens on the outer side of outer annular cylinder (ICL2);
each tube make equal acute angle with respect to radially outward direction in opposite direction along the right circular section of ignition chamber;
surface of the nozzles on the outer side of ignition chamber are cut to take the shape of outer surface of the outer annular cylinder (ICL2) so that ignition chamber can glide inside the
nozzle seal cylinder smoothly and surface of the nozzles on the inner side of ignition chamber are cut to take the shape of inner surface of the inner annular cylinder (ICL1); ignition chamber (IC) extends towards rear side of the nozzle wherein its inner annular cylinder (ICL1) extends longer than the outer annular cylinder (ICL2) towards the rear side.

Nozzle seal (NSL), as shown in FIGS. 2 and 3, which dynamically puts nozzle (NZL) into closed or open phase, consists of three annular cylinders, namely shutter cavity (SHC), shutter (SH) and shutter stopper (SHS), coaxially mounted on outer side of outer cylinder of ignition chamber near nozzle (NZL) and a push-pull solenoid actuator (ACT), wherein
shutter cavity (SHC) is a special type of annular cylinder, whose front portion coaxially holds the outer annular cylinder of ignition chamber (ICL2) with the help of a ball bearing but the rear portion (which is facing nozzle) forms an annular cylindrical cavity with outer annular cylinder of ignition chamber (ICL2) which can house shutter (SH);
shutter (SH) is an annular cylinder coaxially mounted to the rear portion of the shutter cavity (SHC) such that outer annular cylinder of ignition chamber (ICL2) slip fits inside the shutter (SH) and shutter (SH) can be operated by actuator (ACT) to slide in and out of cylindrical annular cavity on the rear portion of shutter cavity (SHC) to unseal and seal the nozzles (NZL) respectively;
shutter stopper (SHS) is an annular cylinder located on the rear side of nozzles (NZL), which coaxially holds the outer annular cylinder of ignition chamber (ICL2), via one or more coaxial ball bearings and to helps to stop shutter (SH) from sliding away;
push-pull actuator (ACT) consists of three-four solenoid coils mounted on the outer side shutter cavity (SHC), which operates the shutter (SH) and works to push and pull the shutter (SH) to slide in and slide out of the cylindrical annular cavity on the rear portion of shutter cavity (SHC);
shutter cavity (SHC), and shutter stopper (SHS) are secured to enclosure (ENC) by rectangular slabs.

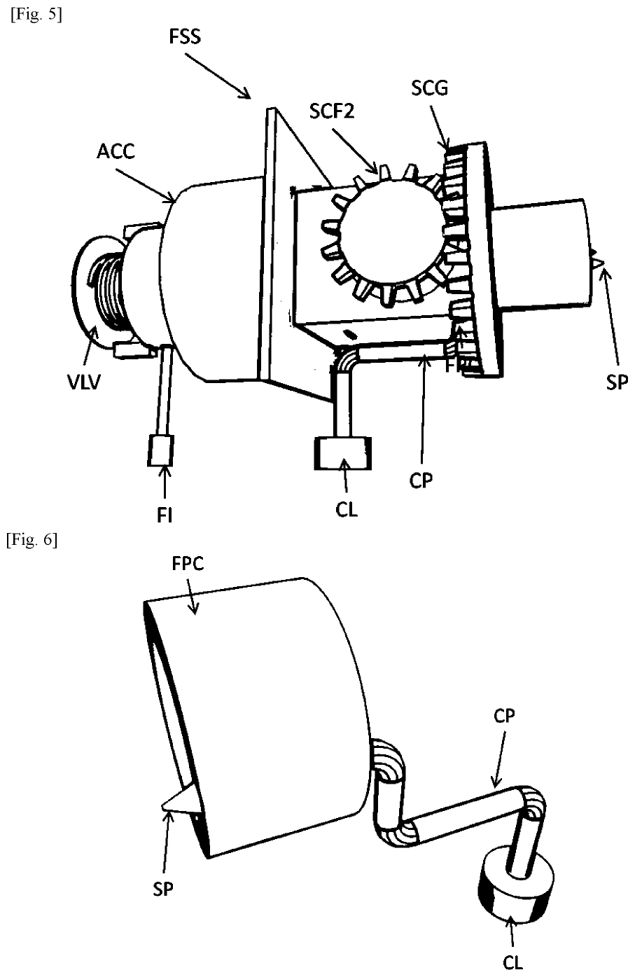

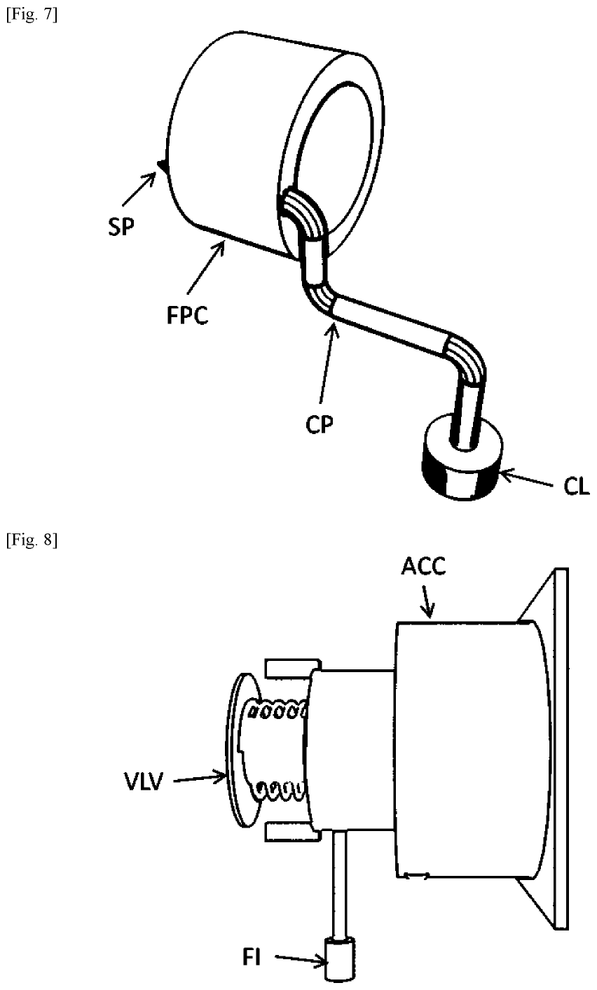

Fuel supply system (FSS), as shown in FIGS. 4 to 11, which is designed for two phase suction-compression followed by combustion of air-fuel mixture in the ignition chamber, consists of Scotch-Yoke operation chamber (SOC), front piston chamber (FPC), air-fuel compression chamber (ACC), fuel delivery and ignition mechanism (FDI) wherein
Scotch-Yoke operation chamber (SOC), as shown in FIGS. 4 and 5, a horizontal rectangular pipe with circular hole in rear and front side, is located between front piston chamber (FPC) and air-fuel compression cylinder (ACC), wherein
front piston chamber (FPC), as shown in FIGS. 4 to 7, being an horizontal annular cylinder slip fit into rearward extension of inner annular cylinder of ignition chamber is sealingly attached at its rear end to the circular hole on the front end of Scotch-Yoke operation chamber (SOC);
air-fuel compression chamber (ACC), as shown in FIGS. 4, 5 and 8, being a horizontal annular cylinder of inner radius greater than and length equal to that of inner annular cylinder of ignition chamber, with a rectangular hole on its front cap and a circular hole on its rear cap, is sealingly attached at its front end to the rear end of Scotch-Yoke operation chamber (SOC);
a cylindrical deck is sealingly attached to the circular hole on the rear cap of air-fuel compression chamber (ACC);
fuel delivery and ignition mechanism (FDI), as shown in FIGS. 4 to 11, consists of a spark-plug (SP), a conduit pipe (CP), an air-fuel valve (VLV), Scotch-Yoke operation mechanism (SYM) and a new type of Scotch-Yoke actuator (SYA);
spark-plug (SP), as shown in FIGS. 4 to 7, is housed in a hole on left side of the wall of front piston chamber (FPC) with its electrode exposed towards nozzle (NZL) in the ignition chamber (IC),
conduit pipe (CP), as shown in FIGS. 4 to 7, containing the wire emanating from rear side of spark-plug is bent vertically downwards to pass through hole on the bottom side of Scotch-Yoke operation chamber (SOC) and then further bent appropriately to lead the wire to the ignition coil (CL);
air-fuel valve (VLV), as shown in FIGS. 4, 5 and 8, is a push to open valve operated by a solenoid coil and is housed in the cylindrical deck on rear end of air-fuel compression chamber (ACC) and is connected to a fuel injector (FI) via a fuel pipe (FP).

Scotch-Yoke operation mechanism (SYM), as shown in FIGS. 4, 5, 9, 10 and 11, consists of a cam gear (CMG), left cam follower gear (CMF1), right cam follower gear (CMF2), left yoke pin base (YPB1), right yoke pin base (YPB2), left cam axis (CA1), right cam axis (CA2), four ball bearings, namely, left outer bearing (B1), right outer bearing (B2), left inner bearing (B3) and right inner bearing (B4), wherein
cam gear (CMG) is a circular annular crown gear with its tooth projecting rearward (that is, towards Scotch-Yoke operation chamber) is coaxially mounted on the rearward extension of the inner annular cylinder of the ignition chamber;
left cam follower gear (CMF1) and right cam follower gear and (CMF2), are spur gears with radius equal to half the radius of cam gear (CMG) coaxially mounted on ball bearings, left outer bearing (B1), and right outer bearing (B2), respectively, attached to outer side the left and right wall, respectively, of Scotch-Yoke operation chamber (SOC);
left cam axis (CA1) and right cam axis (CA2) are straight rods attached at one end to the center of left cam follower gear (CMF1) and right cam follower gear (CMF2) respectively and extends inside the scotch yoke operation chamber (SOC) from latter's left and right wall respectively;
left yoke pin base (YPB1) and right yoke pin base (YPB2) are circular disks (or a metal plate) mounted at their periphery on ball bearings, left inner bearing (B3) and right inner bearing (B4), respectively, which in turn are attached to inner side the left and right wall, respectively, of Scotch-Yoke operation chamber (SOC);
left yoke pin base (YPB1) and right yoke pin base (YPB2) are attached at their center to left cam axis (CA1) and right cam axis (CA2) respectively;
teeth on the front side of left cam follower gear (CMF1) and right cam follower gear (CMF2), meshes with the teeth of cam gear (CMG), on its left and right side respectively.

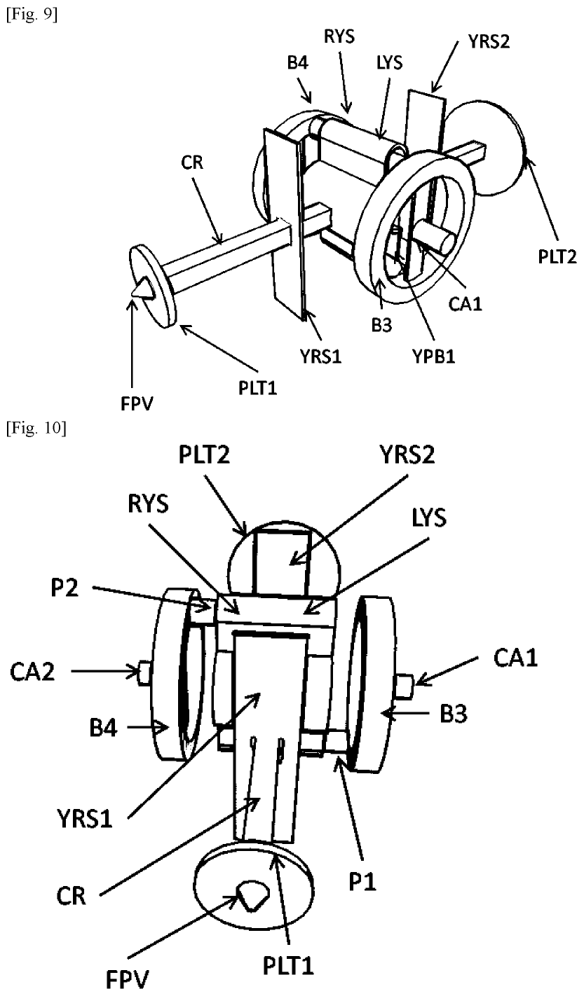

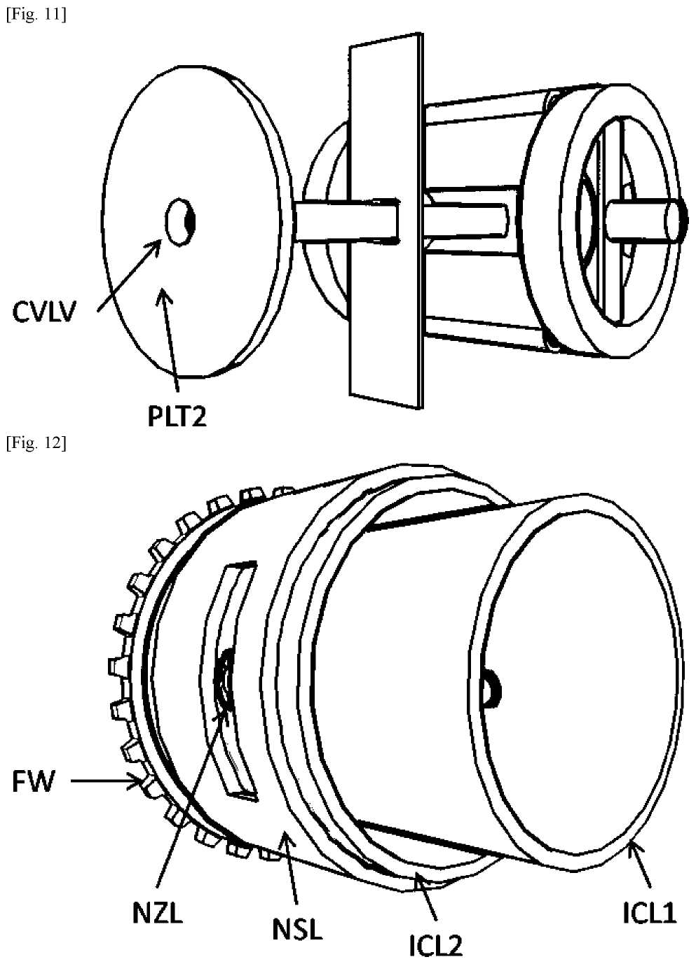

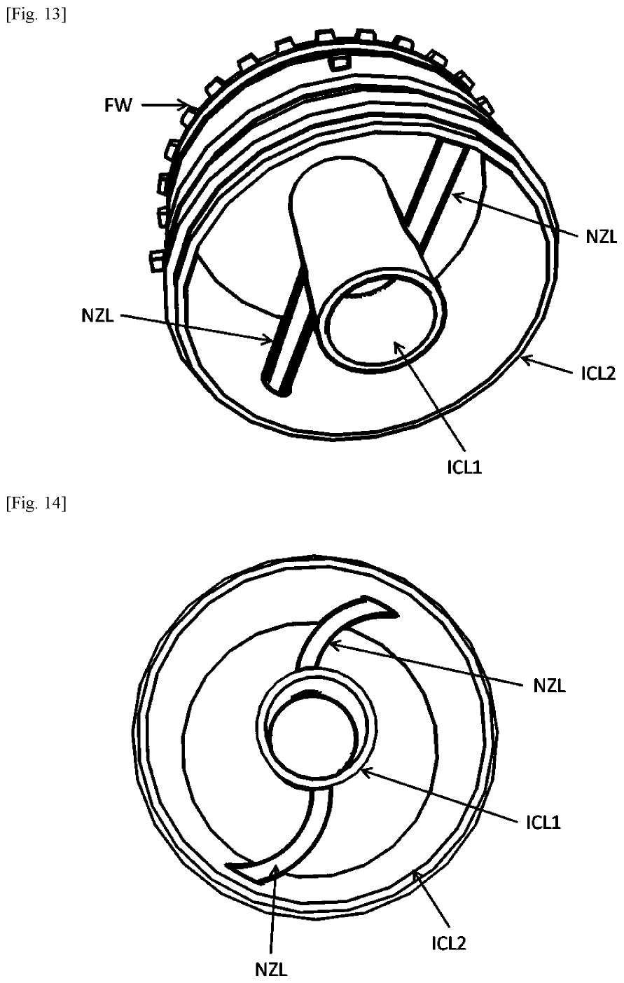

Scotch-Yoke actuator (SYA), as shown in FIGS. 9, 10 and 11, a multi-purpose bilaterally operated double action front dwell scotch-yoke mechanism, consists of yoke slot (YS), a connecting rod (CR), a left yoke pin base (YPB1) and right yoke pin base (YPB2), left yoke pin (P1) and right yoke pin (P2), front yoke rod support (YRS1), and rear yoke rod support (YRS2), front piston plate (PLT1), rear piston plate (PLT2), fuel pressure valve (FPV) and compressor valve (CVLV) wherein
yoke slot (YS), is vertical yoke slot with front end dwell located such that slot opens towards left crank wheel and right crank wheel, vertically partitioned along the mid part to form two slots namely, left yoke slot (LYS) and right yoke slot (RYS);
connecting rod, (CR) is a horizontal rod with a longitudinal coaxial cylindrical hole which attached at its longitudinal center to the center of the yoke slot (YS), so that former passes through the slot;
front piston plate (PLT1) and rear piston plate (PLT2), circular disks with holes at their centers, are attached coaxially to the front and rear end, respectively, of connecting rod;
front piston plate (PLT1) of radius equal to inner radius of front piston chamber (FPC) and is housed coaxially inside the latter;
rear piston plate (PLT2) of radius equal to inner radius of air compression chamber (ACC) and is housed coaxially inside the latter;
fuel pressure valve (FPV) and compressor valve (CVLV) are pressure valves, opening along front side, mounted coaxially to the centers of front piston plate (PLT1) and rear piston plate (PLT2) respectively, so that fuel under pressure can enter through rear end of compressor valve (CVLV) pass through cylindrical hole in the connecting rod (CR) and exit from the front end of fuel pressure valve (FPV);
left yoke pin (P1) and right yoke pin (P2) are small cylindrical pegs projecting out of the periphery of left yoke pin base (YPB1) and right yoke pin base (YPB2), respectively, to engage with left yoke slot (LYS) and right yoke slot (RYS), respectively, in such way that when left yoke pin (P1) is at the upper most point in the yoke slot, then right yoke pin (P2) is at the lowest point in the yoke slot and vice versa;
front yoke rod support, (YRS1) and rear yoke rod support (YRS2) are vertical rods, located inside Scotch-Yoke operation chamber (SOC), on front and rear side, respectively, of the yoke slot wherein front yoke rod support, (YRS1) and rear yoke rod support (YRS2), has a hole through which front arm and rear arm, respectively, of connecting rod (CR) passes through.

In one of the variation to the above fuel supply system front piston plate (PLT1) of scotch-yoke actuator is longer length and fixed coxially along the inner wall of front piston chamber (FPC) and front arm of the connecting rod of the actuator can slide in the hole in the front piston plate (PLT1).

Flywheel (FW), as shown in FIGS. 1 and 2, is an externally teethed circular annular gear that functions as output of the engine and is mounted coaxially to the front side extension of outer cylinder of ignition chamber.

According to one variation to above description, Nozzle seal (NSL), as shown in FIG. 12, used to seal and unseal nozzle (NZL), is an annular cylinder which holds outer annular cylinder (ICL2) of the ignition chamber via ball bearing such that
its middle portion falls above the nozzle (NZL);
its length is such that outer annular cylinder (ICL2) is exposed on its rear and front side;
its middle portion has two rectangular holes at diametrically opposite sides, with length of each hole is such that they subtend an angle of 60 degree (may be calibrated according to the requirement) at the center of the circle and width little greater than the diameter of the outer aperture of nozzles;
thrust vectoring nozzle (NZL) remain sealed except when passes under gas exiting holes of nozzle seal (NSL).

According to another variation to above description, thrust vectoring nozzle (NZL) consists of pair of curved conical tubes so that escape angle of gas at outer surface of outer cylinder (ICL2) of ignition chamber can be closer to tangent of circle described by nozzles with aperture of nozzles inside the inner cylinder (ICL1) of ignition chamber, is along radial direction.

### Scotch-Yoke Operation:

Rotation of ignition chamber causes suction cam gear to rotate which in turn causes left and right suction cam follower gear to rotate in opposite direction (one in clockwise and other in anticlockwise direction). Since left and right suction cam follower gear to rotate in opposite directions, left scotch-yoke pin will move in yoke slot from top towards bottom while right scotch-yoke pin will move in yoke slot from bottom towards top and vice versa. Distances of left scotch pin and right scotch pin from center of yoke slot will always be equal. Note that vertical component sideward thrust exerted on the yoke support by one yoke pin gets cancelled out by that of other pin.

### Engine Operation for Stationary Nozzle Seal:

Each half rotation of ignition chamber and therefore of flywheel is divided into three phases namely suction phase, compression phase, combustion phase causing rotatory thrust due to hot air exhaust. When scotch-yoke moves in forward direction, nozzles are in closed state and air-fuel mixture in the ignition chamber is compressed, and at the same time air-fuel mixture is sucked into rear side compression cylinder. When scotch-yoke moves in rearward direction nozzles are in closed state, air-mixture is being compressed in rear compressor cylinder and simultaneously transmitted to ignition chamber and air-fuel mixture sucked into ignition chamber due to rearward movement of front piston. During combustion phase scotch pins in dwell part of yoke slot and nozzles are open and compressed air-fuel mixture is ignited. At this state since scotch pins are dwell part of yoke slot front piston is forced to stay at the dead end due to which hot air gushes out of nozzles to cause coupling torque action resulting in rotatory thrust on the ignition chamber. A separate phase to expel burnt gas is not required. Fuel valve doesn't come in contact with combustion chamber.

1. A specially designed bilaterally operated multi-purpose double action scotch-yoke based rotary engine with reciprocating fuel suction and compression system and two phase fuel compression system, for directly converting the fuel energy to rotatory motion using thrust vectoring of ignited fuel, consisting of an engine enclosure, thrust vectoring ignition chamber, fuel supply system, nozzle seal and flywheel.

2. Engine enclosure, claimed in [claim 1], appropriately secures all parts of engine, provides support to engine via rectangular slabs attached to outer static parts of engine like nozzle seal and scotch yoke operation chamber of fuel supply system, claimed in [claim 1], and provides exit to the burnt fuel gas via exhaust pipe.

3. Thrust vectoring ignition chamber, claimed in [claim 1], consists of a pair of coaxial annular cylinders, an inner annular cylinder and an outer annular cylinder, connected coaxially via coaxial rings, and coupled thrust vectoring nozzle wherein
inner annular cylinder is coaxially fixedly caped at its front side by ignition chamber seal which is a circular disk;
fuel supply system is mounted on rear side of the ignition chamber;
coupled thrust vectoring nozzle is a pair of conical tubes mounted at diametrically opposite points on the right circular section on the middle part of ignition chamber by passing through holes on the inner annular cylinder and outer annular cylinder such that one end with bigger aperture opens inside the inner annular cylinder and other end with smaller aperture opens on the outer side of outer annular cylinder;
each tube make equal acute angle with respect to radially outward direction in opposite direction along the right circular section in middle portion of ignition chamber;
surface of the nozzles on the outer side of ignition chamber are cut to take the shape of outer surface of the outer cylinder so that ignition chamber can glide inside the nozzle seal cylinder smoothly and surface of the nozzles on the inner side of ignition chamber are cut to take the shape of inner surface of the inner annular cylinder;
ignition chamber extends towards rear side of the nozzle wherein its inner annular cylinder extends longer than the outer annular cylinder towards the rear side.

4. Nozzle seal, claimed in [claim 1], which dynamically puts nozzle into closed or open phase, consists of three annular cylinders, namely shutter cavity, shutter and shutter stopper, coaxially mounted on outer side of outer cylinder of ignition chamber near nozzle and a push-pull solenoid actuator, wherein
shutter cavity is a special type of annular cylinder, whose front portion coaxially holds the outer annular cylinder of ignition chamber with the help of a ball bearing but the rear portion (which is facing nozzle) forms an annular cylindrical cavity with outer annular cylinder of ignition chamber which can house shutter;
shutter is an annular cylinder coaxially mounted to the rear portion of the shutter cavity such that outer annular cylinder of ignition chamber slip fits inside the shutter and shutter can be operated by actuator to slide in and out of cylindrical annular cavity on the rear portion of shutter cavity to unseal and seal the nozzles respectively;
shutter stopper is an annular cylinder located on the rear side of nozzles, which coaxially holds the outer annular cylinder of ignition chamber, via one or more coaxial ball bearings and to helps to stop shutter from sliding away;
push-pull actuator consists of three-four solenoid coils mounted on the outer side of shutter cavity, which operates the shutter and works to push and pull the shutter to slide in and slide out of the cylindrical annular cavity on the rear portion of shutter cavity;
push-pull actuator is timed in a way that it put the nozzle in open state only at the end of ignition phase when compressed fuel gas is ignited and raised to a sufficient pressure to cause considerable rotary thrust upon exit through nozzle and put the nozzle in closed state after the ignited gas has exited through nozzle;
shutter cavity, and shutter stopper are secured to engine enclosure by rectangular slabs.

5. Fuel supply system, claimed in [claim 1], which is designed for two phase suction-compression followed by combustion of air-fuel mixture in the ignition chamber, consists of Scotch-Yoke operation chamber, front piston chamber, air-fuel compression chamber, fuel delivery and ignition mechanism wherein
Scotch-Yoke operation chamber, a horizontal rectangular pipe with circular hole in rear and front side, is located between front piston chamber and air-fuel compression chamber;
front piston chamber being an horizontal annular cylinder slip fit into rearward extension of inner annular cylinder of ignition chamber is sealingly attached at its rear end to the circular hole on the front end of Scotch-Yoke operation chamber;
air-fuel compression chamber, being a horizontal annular cylinder of inner radius greater than and length equal to that of inner annular cylinder of ignition chamber, with a rectangular hole on its front cap and a circular hole on its rear cap, is sealingly attached at its front end to the rear end of Scotch-Yoke operation chamber;
a cylindrical deck is sealingly attached to the circular hole on the rear cap of air-fuel compression chamber;
fuel delivery and ignition mechanism, consists of a spark-plug, a conduit pipe, an air-fuel valve, Scotch-Yoke operation mechanism and a new type of Scotch-Yoke actuator;
spark-plug is housed in a hole on left side of the wall of front piston chamber with its electrode exposed towards nozzle in the ignition chamber;
conduit pipe containing the wire emanating from rear side of spark-plug is bent vertically downwards to pass through hole on the bottom side of Scotch-Yoke operation chamber and then further bent appropriately to lead the wire to the ignition coil;
air-fuel valve is a push to open valve operated by a solenoid coil and is housed in the cylindrical deck on rear end of air-fuel compression cylinder and is connected to a fuel injector via a fuel pipe.

6. Scotch-Yoke operation mechanism, claimed in [claim 5], consists of a cam gear, left cam follower gear, right cam follower gear, left yoke pin base, right yoke pin base, left cam axis, right cam axis, four ball bearings, namely, left outer bearing, right outer bearing, left inner bearing and right inner bearing, wherein
cam gear is a circular annular crown gear with its tooth projecting rearward (that is, towards Scotch-Yoke operation chamber) is coaxially mounted on the rearward extension of the inner annular cylinder of the ignition chamber;
left cam follower gear and right cam follower gear are spur gears with radius equal to half the radius of cam gear coaxially mounted on ball bearings, left outer bearing, and right outer bearing, respectively, attached to outer side the left and right wall, respectively, of Scotch-Yoke operation chamber;
left cam axis and right cam axis are straight rods attached at one end to the center of left cam follower gear and right cam follower gear respectively and extends inside the scotch yoke operation chamber from latter's left and right wall respectively;
left yoke pin base and right yoke pin base are circular disks (or a metal plate) mounted at their periphery on ball bearings, left inner bearing and right inner bearing, respectively, which in turn are attached to inner side the left and right wall, respectively, of Scotch-Yoke operation chamber;
left yoke pin base and right yoke pin base are attached at their center to left cam axis and right cam axis respectively;
teeth on the front side of left cam follower gear and right cam follower gear, meshes with the teeth of cam gear, on its left and right side respectively.

7. Scotch-Yoke actuator, claimed in [claim 5], a multi-purpose multi-purpose bilaterally operated double action front dwell scotch-yoke mechanism, consists of yoke slot, a connecting rod, a left yoke pin base and right yoke pin base, left yoke pin and right yoke pin, front yoke rod support, and rear yoke rod support, front piston plate, rear piston plate, fuel pressure valve and compressor valve wherein
yoke slot, is vertical yoke slot with front end dwell located such that slot opens towards left crank wheel and right crank wheel, vertically partitioned along the mid part to form two slots namely, left yoke slot and right yoke slot;
connecting rod, is a horizontal rod with a longitudinal coaxial cylindrical hole which attached at its longitudinal center to the center of the yoke slot, so that former passes through the slot;
front piston plate and rear piston plate, circular disks with holes at their centers, are attached coaxially to the front and rear end, respectively, of connecting rod;
front piston plate of radius equal to inner radius of front piston chamber and is housed coaxially inside the latter;
rear piston plate of radius equal to inner radius of air compression chamber and is housed coaxially inside the latter;
fuel pressure valve and compressor valve are pressure valves, opening along front side, mounted coaxially to the centers of front piston plate and rear piston plate respectively, so that fuel under pressure can enter through rear end of compressor valve pass through cylindrical hole in the connecting rod and exit from the front end of fuel pressure valve;
left yoke pin and right yoke pin, are small cylindrical pegs projecting out of the periphery of left yoke pin base and right yoke pin base, respectively, to engage with left yoke slot and right yoke slot, respectively, in such way that when left yoke pin is at the upper most point in the yoke slot, then right yoke pin is at the lowest point in the yoke slot and vice versa;
front yoke rod support and rear yoke rod support are vertical rods, located inside Scotch-Yoke operation chamber, on front and rear side, respectively, of the yoke slot wherein front yoke rod support and rear yoke rod support, has a hole through which front arm of the connecting rod and rear arm of the connecting rod, respectively passes through.

8. Flywheel, claimed in [claim 1], is an externally teethed circular annular gear that functions as output of the engine and is mounted coaxially to the front side extension of outer cylinder of ignition chamber.

9. In one of the variation to the above fuel supply system front piston plate of scotch-yoke actuator is longer length and fixed coaxially along the inner wall of front piston chamber and front arm of the connecting rod of the actuator can slide in the hole in the front piston plate.

10. Thrust vectored ignition chamber engine described above is an engine which can use petrol as fuel and in order to use diesel as a fuel we need to replace spark plug with pressure valve, spark plug tube with a pipe that connected to fuel source, ignition coil with fuel source, air-fuel valve with air valve.

11. According to one variation to above description, nozzle seal, used to seal and unseal nozzle, is an annular cylinder which holds outer annular cylinder of the ignition chamber via ball bearing such that
its middle portion falls above the nozzle;
its length is such that outer annular cylinder is exposed on its rear and front side;
its middle portion has two rectangular holes at diametrically opposite sides, with length of each hole is such that they subtend an angle of 60 degree (may be calibrated according to the requirement) at the center of the circle and width little greater than the diameter of the outer aperture of nozzles;
above mentioned rectangular holes are such that thrust vectoring nozzle remain sealed except for time interval during which highly pressurized ignited gas is scheduled to pass through it to cause rotary thrust on the ignition chamber.

12. According to another variation to above description, thrust vectoring nozzle consists of pair of curved conical tubes so that escape angle of gas at outer surface of outer annular cylinder of ignition chamber can be closer to tangent of circle described by nozzles with aperture of nozzles inside the inner annular cylinder of ignition chamber, is along radial direction.
